(19) United States
(12) Patent Application Publication
(10) Pub. No.: US 2011/0183308 A1
(43) Pub. Date: Jul. 28, 2011

(54) METHOD FOR ENHANCING ATTENTION AND CONCENTRATION

(76) Inventors: Shih-Chung Hsu, Tainan City (TW); Te-Jung Hsu, Tainan City (TW); Tsui-Wen Hsu, Tainan City (TW); Tsui-Yin Sung Hsu, Kaohsiung County (TW)

(21) Appl. No.: 12/694,540

(22) Filed: Jan. 27, 2010

(51) Int. Cl. G09B 19/00

(52) U.S. Cl. 434/258

(57) ABSTRACT

A method for enhancing attention and concentration includes a step of preparing a target of different purposes; a step of choosing one of the purposes of the target; a step of watching the target; a step of blocking the sight between the tester and the target, and a step of moving tester's limbs to complete commands of the target.

### FIELD OF THE INVENTION

The present invention relates to a method, and more particularly, to a method for enhancing attention and concentration.

### BACKGROUND OF THE INVENTION

The attention and concentration represent the status of the memory, observation, imagination, thinking, if the attention cannot be well established, people cannot have organized ability mentioned above. Therefore, the brain nerves can be trained by proper training to enhance the processing speed to the information and data received in the brain so as to coordinate the movement of the body and enhance the attention and concentration. There are two test devices for judge the attention and the concentration and both of which include a body with light source, timer, counting system, operation disk on the body and multiple test transparent boards of different shapes. When using the device, the operator rotates the operation disk and the light source emits light through the test boards to generate light trace. The tester holds a trace bar to trace the light trace. The timer and the counting system calculate the numbers of the correct and wrong tracing actions to judge the attention and concentration of the tester.

Nevertheless, the conventional way to judge the attention and concentration of the tester can only obtain the ability of the tester when the tester' eyes are open, and cannot evaluate the attention and concentration when the tester's eye are closed. Furthermore, the test devices can only disclose the times that the tester correctly or wrongly traces the light trace, and cannot actually disclose the attention and concentration of the tester. Besides, the tester has to control his/her mind to use the trace bar, and this usually makes the tester to be too nervous to tight his/her muscles and even affect the quality of sleep.

The present invention intends to provide a method for enhancing attention and concentration and the tester does not need to operate a trace bar to follow the light trace. The tester can complete the test in a non-nervous status to have better result.

### SUMMARY OF THE INVENTION

The present invention relates to a method for enhancing attention and concentration, and the method comprises the following steps:

a. preparing a target of different purposes;

b. choosing one of the purposes of the target;

c. tester watching the target;

d. blocking the sight between the tester and the target, and

e. moving tester's limbs to complete commands of the target.

The target includes multiple concentric circles and a center is centrally located at the multiple concentric circles. The outer most concentric circle has multiple number zones. Each concentric circle and the center have different colors.

One of purposes of the method is to test the attention of the tester, the commands require the tester to put the tester's limbs on the correspondent number zones according to the complementary image in the tester's brain.

One of purposes of the method is to test the concentration, the positioning and movement of the tester, the commands require the tester to put the tester's limbs on the correspondent number zones according to the complementary image in the tester's brain.

Preferably, the limbs are fingers.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the flow charts of the method of the present invention;

FIG. 2 shows the device cooperated with the method of the present invention, and

FIG. 3 shows an enlarged view of the device in FIG. 2.

### DETAILED DESCRIPTION OF THE PREFERRED EMBODIMENT

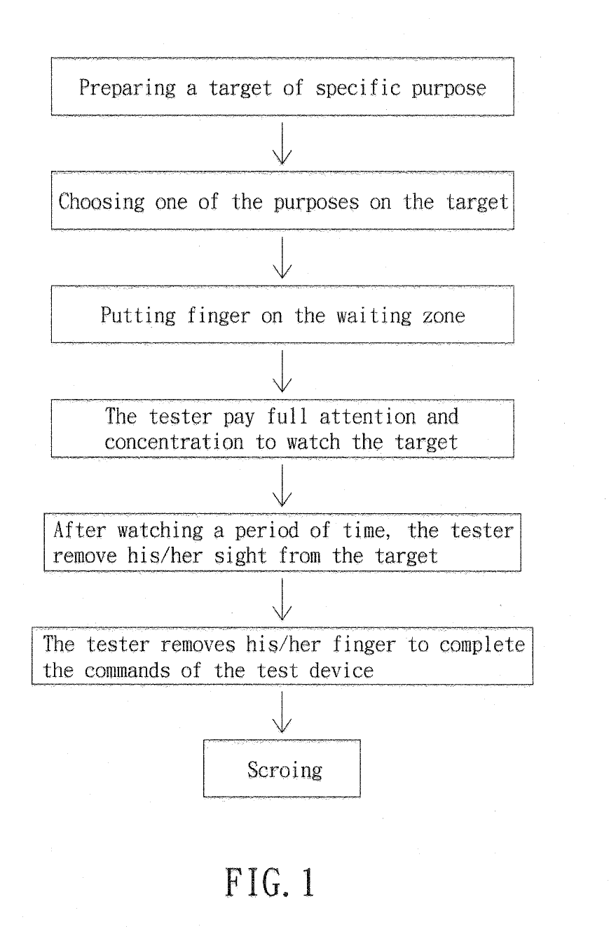

Referring to FIG. 1, the method of the present invention comprises the following steps:

a. preparing a target 1 of different purposes;

b. choosing one of the purposes of the target 1;

c. tester watching on the target 1;

d. blocking the sight between the tester and the target 1, and

e. moving tester's limbs to complete commands of the target 1.

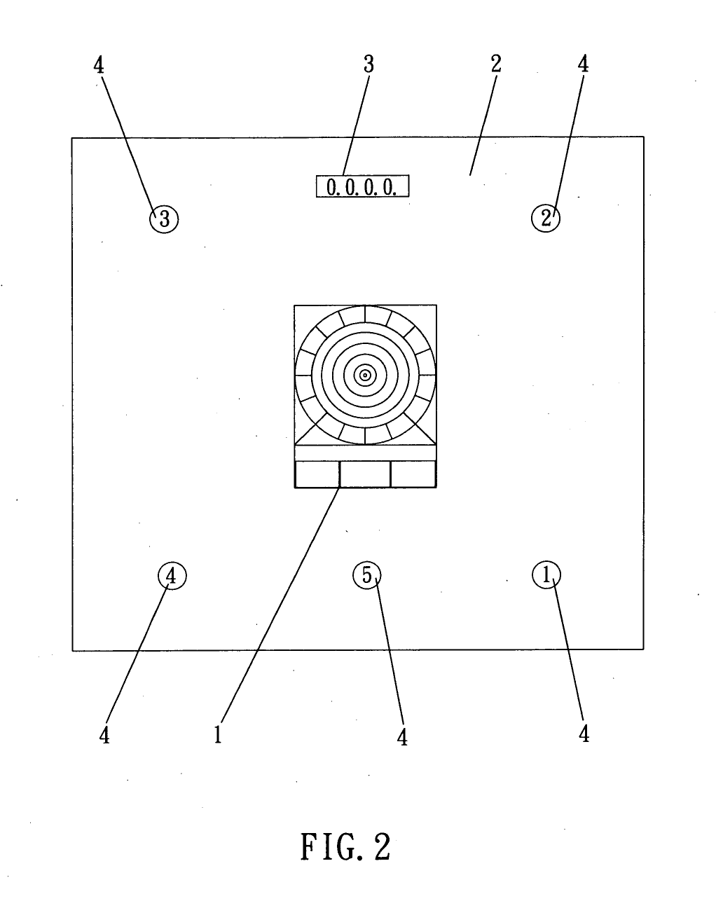

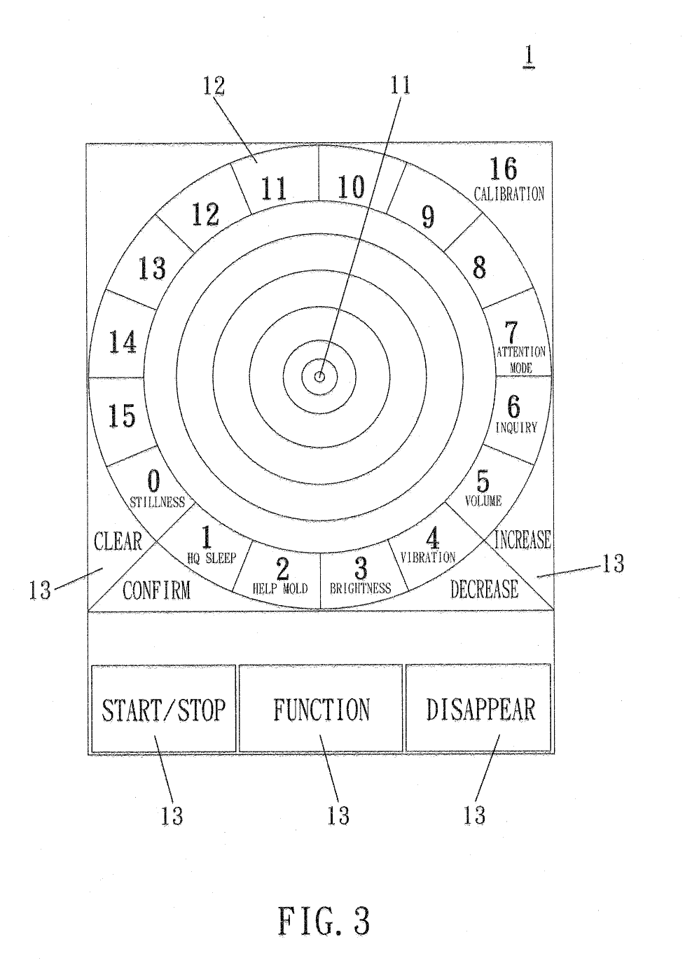

Referring to FIGS. 2 and 3, the device for cooperation of the method of the present invention comprises a body 2 on which the target 1 is located. The body 2 includes control system, indication system and scoring system received therein, and all of the three systems are not shown in the drawings. A control panel is located on the body 2 and beneath the target. There are one score display zone 3 and multiple waiting zones 4 located around the target 1. The score display zone 3 and multiple waiting zones 4 are separated from the targets at different distances.

The target 1 includes multiple concentric circles and a center 11 is centrally located at the multiple concentric circles. The outer most concentric circle has multiple number zones 12, and each concentric circle and the center 11 have different colors. There are buttons 13 are located around the outer most concentric circle.

One of purposes of the method is to test the attention of the tester, the commands require the tester to put the tester's limbs on the correspondent number zones 12 according to the complementary image in the tester's brain. The other one of purposes of the method is to test the concentration, the positioning and the movement of the tester, the commands require the tester to put the tester's limbs on the correspondent number zones 12 according to the complementary image in the tester's brain. The limbs are fingers preferably.

When testing the attention, the following steps are taken:

a. preparing a target 1 of specific purpose as shown in FIGS. 2 and 3;

b. choosing the number zone indicating the “attention mode” to set the purpose and the tester puts his/her finger on the wanting zone 4 or the button indicating “disappear”;

c. the tester pay full attention to watch the target;

d. after watching a period of time, the tester closes his/her eyes or turns his/her head away from the target 1 according the indication from the body, and

e. the tester removes his/her finger and put the finger on the number zone 12 in the correspondent colored centric circle right after the complementary image in the tester's brain disappears, the scoring system calculate the scores which are displayed in the score display zone 3.

When testing the concentration, the positioning and the movement of the tester, the following steps are taken:

a. preparing a target 1 of specific purpose as shown in FIGS. 2 and 3;

b. choosing the number zone indicating the “concentration mode” to set the purpose and the tester puts his/her finger on the wanting zone 4 or the button indicating “disappear”;

c. the tester pay full concentration to watch the target;

d. after watching a period of time, the tester closes his/her eyes or turns his/her head away from the target 1 according the indication from the body, and

e. the tester removes his/her finger and put the finger on the position that is closest to the center of the target 1 right after the complementary image in the tester's brain disappears, the scoring system calculate the scores which are displayed in the score display zone 3.

The method is cooperated with the test device allow the tester to complete the test to enhance attention and concentration without too much stress and can transfer negative mood to calm down completely.

While we have shown and described the embodiment in accordance with the present invention, it should be clear to those skilled in the art that further embodiments may be made without departing from the scope of the present invention.

What is claimed is:

1. A method for enhancing attention and concentration, comprising the following steps:
a. preparing a target of specific purpose;
b. choosing one of the purposes of the target;
c. tester watching the target;
d. blocking the sight between the tester and the target, and
e. moving tester's limbs to complete commands of the target.

2. The method as claimed in claim 1, wherein the tester pays full attention and concentration to watch the target.

3. The method as claimed in claim 1, wherein the target includes multiple concentric circles and a center is centrally located at the multiple concentric circles, the outer most concentric circle has multiple number zones, each concentric circle and the center have different colors.

4. The method as claimed in claim 3, wherein one of purposes of the method is to test the attention of the tester, the commands require the tester to put the tester's limbs on the correspondent number zones according to the complementary image in the tester's brain.

5. The method as claimed in claim 3, wherein one of purposes of the method is to test the concentration, the position and the movement of the tester, the commands require the tester to put the tester's limbs on the correspondent number zones according to the complementary image in the tester's brain.

6. The method as claimed in claim 1, wherein the limbs are fingers.
